(19) United States
(12) Patent Application Publication
(10) Pub. No.: US 2015/0331491 A1
(43) Pub. Date: Nov. 19, 2015

(54) SYSTEM AND METHOD FOR GESTURE BASED TOUCHSCREEN CONTROL OF DISPLAYS

(71) Applicant: THOMSON LICENSING, Issy les Moulineaux (FR)

(72) Inventor: Mark Francis Rumreich, Indianapolis, IN (US)

(73) Assignee: Thomas Licensing

(21) Appl. No.: 14/655,652

(22) PCT Filed: Dec. 27, 2012
(86) PCT No.: PCT/US2012/071690

§ 371 Date: Jun. 25, 2015

(51) Int. Cl. G06F 3/01; G06F 3/041; G06F 3/0488; G06F 3/00

(52) U.S. Cl. CPC G06F 3/017; G06F 3/005; G06F 3/011; G06F 3/0412; G06F 3/0488; G06F 2203/04808

(57) ABSTRACT

Methods and apparatus are provided for a gesture based touchscreen for control of a display. The methods and apparatus capture a reference image and identify portions of the captured image corresponding to a reference image, or corresponding to a known image portion, such as a pushbutton. The method processes portions of the captured image relative to the displayed or known image portion and generates a measure, such as a difference. The method also determines whether the measure, such as the difference, exceeds a threshold for at least some period of time, to determine whether to take some action in response to the determination. The action taken could correspond to the pushbuttons on the display

### FIELD OF THE INVENTION

The present principles relate to a system and method for controlling a display using a gesture based touchscreen.

### BACKGROUND OF THE INVENTION

Touchscreens have become very common in devices such as smartphones, games, cameras, and tablets. Picoprojectors and full-size projectors could become more useful with the addition of touchscreen capabilities at the projected image surface. But since front-projectors use a simple fabric screen or even a wall to display the image, there is no convenient touch sensor for adding touchscreen functionality. Furthermore, physically touching a wall or screen can be inconvenient or create finger marks on a wall or screen, and is undesirable.

A first prior art gaming system uses gesturing, but not in conjunction with blocking a projected image on a screen or wall. A second prior art approach uses a virtual keyboard that projects virtual buttons, but uses an invisible infrared (IR) layer of light to detect a button press. Approaches that use infrared or heat sensors to detect gestures have several disadvantages, including reduced performance in hot ambient environments. In addition, the IR approach will not work if a ruler or some other object is used instead of a human body part to point at the display.

### SUMMARY OF THE INVENTION

The methods and apparatus described herein relate to a convenient method for interfacing with projected pictures, presentations and video that addresses the drawbacks and disadvantages of prior approaches. Group participation by others at a conference table, for example, is possible using the methods described herein by anyone extending their hand or an object in front of a camera.

The methods described herein operate using visible light. Visible light offers the advantage that any type of pointer, not just human body parts, will work to control the interface. The principles also work well in hot ambient environments in contrast to an IR approach. This approach takes advantage that many devices already include a camera.

According to one embodiment of the present principles, there is provided a method for interfacing with a reference image. The method comprises the steps of capturing an image. The image can, of course, be one image in a video sequence. The method further comprises identifying a portion of the captured image that corresponds to a reference image. The reference image can be a stored image, but can also be a portion of a previously captured image. The method further comprises normalizing said identified portion of the captured image with respect to the reference image, calculating a difference between the normalized portion of the captured image and the reference image for at least one image region, and determining if any difference exceeds a threshold for at least some period of time.

According to another embodiment of the present principles, there is provided a method for interfacing with a reference image. The method comprises the step of capturing an image comprising pushbuttons. The image can, of course, be one image in a video sequence. The method further comprises identifying regions of the image comprising pushbuttons in the captured image. The method also comprises comparing a measure of the regions comprising pushbuttons with respect to each other; and determining if any measure exceeds a threshold for at least some period of time and taking an action in response to the determining step.

According to another embodiment of the present principles, there is provided an apparatus for interfacing with a reference image. The apparatus comprises a camera that captures an image, and an image reference matcher for identifying a portion of the captured image that corresponds to a reference image. The apparatus further comprises a normalizer for normalizing said identified portion of the captured image with respect to the reference image, a difference calculator for generating a difference between the normalized portion of the captured image and the reference image for at least one image region and a comparator for determining if at least one difference exceeds a threshold for at least some period of time. The apparatus further comprises circuitry for taking an action in response to said comparator determination.

These and other aspects, features and advantages of the present principles will become apparent from the following detailed description of exemplary embodiments, which are to be read in connection with the accompanying drawings.

### BRIEF DESCRIPTION OF THE DRAWINGS

FIG. 1 shows a display interace, in accordance with the present principles.

FIG. 2 shows one embodiment of a method in accordance with the present principles.

FIG. 3 shows a second embodiment of a method in accordance with the present principles.

FIG. 4 shows an embodiment of an apparatus in accordance with the present principles.

### DETAILED DESCRIPTION

The principles described herein provide a solution to control of a display using a gesture based touchscreen. Picoprojectors and full-size projectors could become more useful with the addition of touchscreen capabilities at the projected image surface. But since front-projectors use a simple fabric screen or even a wall to display the image, there is no convenient touch sensor for adding touchscreen functionality. Furthermore, physically touching a wall or screen can be inconvenient or create finger marks on a wall or screen, and is undesirable.

Incorporating a camera into a projector would allow a gesture-based “touchscreen interface” to be implemented. Hand motions such as “park” or “move and freeze” in front of projected pushbuttons could be used to activate the pushbuttons, or for example, to cause actions such as moving to a next slide or going back to a previous slide. “Park” can mean holding a hand over a button for at least some predetermined time as a further example. “Move and freeze” could mean motion followed by non-motion. These are just some examples, but other types of gestures could be used as well to control all sorts of actions.

Some mobile phones include picoprojectors, and most already include cameras, so adding a gesture-based touchscreen interface becomes valuable.

Another potential advantage of this method is that the hand motion need not be in close proximity to the screen surface, it could be nearer the projector itself, convenient to the presenter. Group participation by others at the table is now feasible because anyone can stick their hand out to activate a displayed menu button.

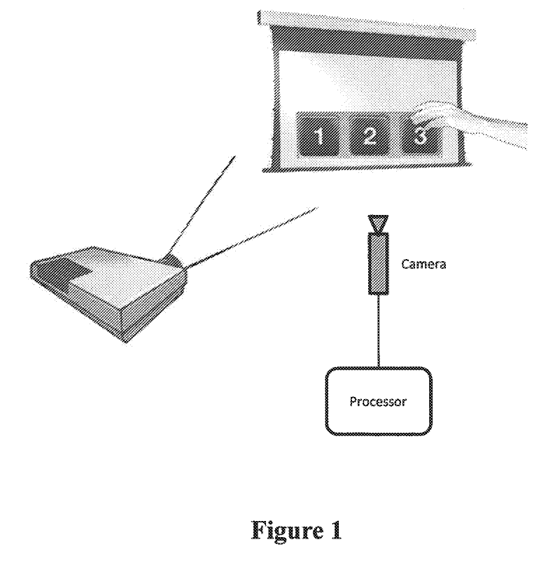

In a similar embodiment, the presence of a hand in front of any portion of the reference image could activate the display of a menu having buttons. One embodiment of the present principles is shown in FIG. 1, which shows a projector, the projected image comprising a few pushbuttons, a processor and a camera. The processor is in signal communication with a camera. Although the signal is shown being communicated by way of a wired connection, wireless connections can also be used with the present principles.

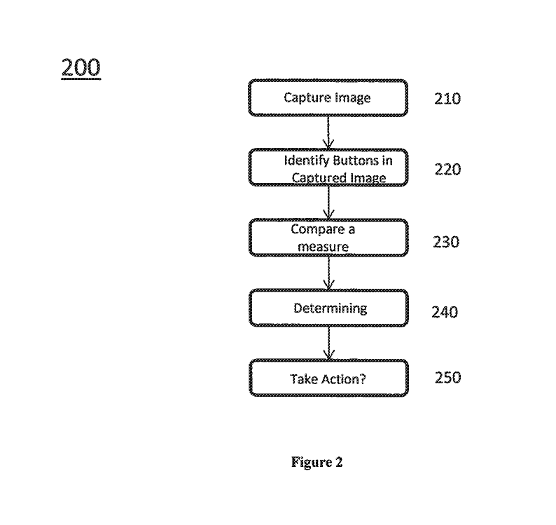

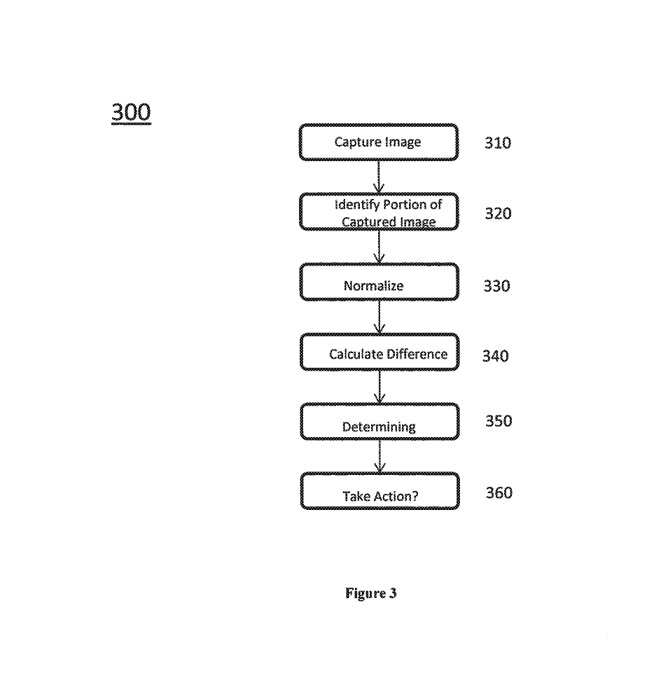

Two embodiments of a method under the present principles are shown in FIGS. 2 and 3 and described below.

To a human eye, detecting a hand obstructing a portion of a projected image is simple. To detect this electronically requires more sophistication. A first embodiment of a method 200 to implement the principles of the present system is shown in FIG. 2.

In one embodiment, buttons are displayed for use in controlling the action of a display, such as in FIG. 1. In this embodiment, one alternative to steps 230 and 240 would be to directly compare the regions containing the pushbuttons in the captured image with respect to each other if the pushbutton regions are designed to be similar. One embodiment of this implementation is a method 200 for interfacing with a reference image, comprising the step 210 of capturing a reference image, and a step 220 of identifying regions comprising pushbuttons in the captured image. The method is further comprised of a step 230 of comparing a measure of the regions comprising pushbuttons with respect to each other. This could be simple if a region comprising a pushbutton is known to be a certain size, and the captured portion size is used for the comparison. The method is further comprised of a step 240 of determining if any measure exceeds a threshold for at least some period of time, and a step 250 of taking an action in response to the determining step. The action taken could correspond to a particular pushbutton on the display.

Another embodiment of the present method is shown in FIG. 3. The method 300 operates on a reference image, such as an image from a projector, for example. However, the method could also operate on other types of reference images. Reference images could be stored in memory and read from memory when comparing with a captured image. Reference images can also be previously captured images, such as images from the last frame. Frame capture times can be relatively slow compared to normal video, but can also be at normal video frame rates. The method comprises the step 310 of capturing an image containing a reference image with a camera and the step 320 of identifying the portion of the captured image that corresponds to the reference image. For example, a projector may be displaying a viewgraph on a wall or screen. The camera capturing this image may capture a larger portion of the wall than just the viewgraph. The reference image, the displayed viewgraph, is just one portion of the captured image. The method is further comprised of a step 330 of normalizing the portion of the captured image with respect to the reference image, and a step 340 of calculating the difference between the normalized portion of the captured image and the reference image for at least one image region. Normalization is performed so that the captured portion of the image corresponding to the reference image is similar to the reference. Similarity may include, but is not limited to, size, shape, luminance or chrominance variations. Simpler variations of this procedure could be used. Step 320 (identifying a portion of the captured image that corresponds to the reference image) may be very simple, or unnecessary, if the projector, or other displaying device, and the camera are designed to have fixed fields of view.

The method is further comprised of a step 350 of determining if any difference exceeds a threshold for at least some period of time, and step 360 of taking an action in response to the determining step. The comparison step could use full color, luma-only, or a weighted sum of red, green, and blue (RGB) designed to optimize contrast between a human hand and a screen.

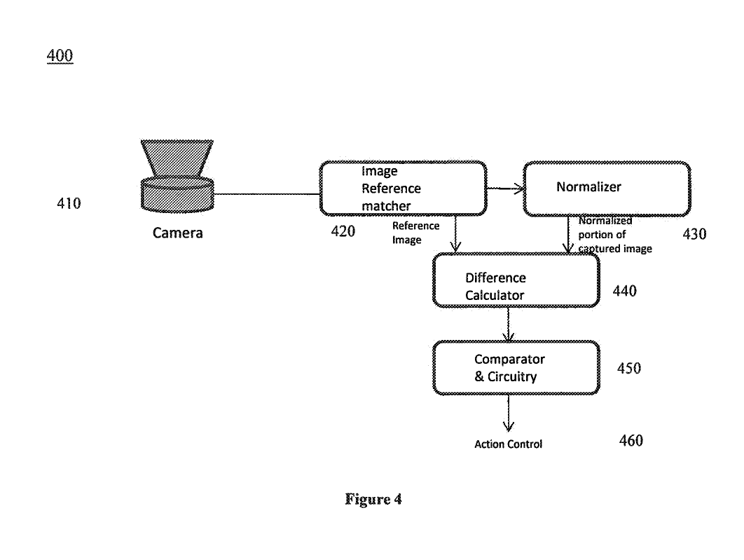

One exemplary embodiment of an apparatus 400 for implementing the present principles is shown in FIG. 4. The apparatus comprises a camera 410 that captures an image. The apparatus further comprises an image reference matcher 420 for identifying a portion of the captured image that corresponds to a reference image and a normalizer 430 for normalizing the identified portion of the captured image with respect to the reference image. The apparatus further comprises a difference calculator 440 for generating a difference between the normalized portion of the captured image and the reference image for at least one image region. The apparatus further comprises a comparator 450 for determining if at least one difference exceeds a threshold for at least some period of time and circuitry 460 for taking an action in response to the comparator determination.

One or more implementations having particular features and aspects of the presently preferred embodiments of the invention have been provided. However, features and aspects of described implementations can also be adapted for other implementations. For example, these implementations and features can be used in the context of other video devices or systems. The implementations and features need not be used in a standard.

Reference in the specification to “one embodiment” or “an embodiment” or “one implementation” or “an implementation” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment” or “in one implementation” or “in an implementation”, as well any other variations, appearing in various places throughout the specification are not necessarily all referring to the same embodiment.

The implementations described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or computer software program). An apparatus can be implemented in, for example, appropriate hardware, software, and firmware. The methods can be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Implementations of the various processes and features described herein can be embodied in a variety of different equipment or applications. Examples of such equipment include a web server, a laptop, a personal computer, a cell phone, a PDA, and other communication devices. As should be clear, the equipment can be mobile and even installed in a mobile vehicle.

Additionally, the methods can be implemented by instructions being performed by a processor, and such instructions (and/or data values produced by an implementation) can be stored on a processor-readable medium such as, for example, an integrated circuit, a software carrier or other storage device such as, for example, a hard disk, a compact disc, a random access memory (“RAM”), or a read-only memory (“ROM”). The instructions can form an application program tangibly embodied on a processor-readable medium. Instructions can be, for example, in hardware, firmware, software, or a combination. Instructions can be found in, for example, an operating system, a separate application, or a combination of the two. A processor can be characterized, therefore, as, for example, both a device configured to carry out a process and a device that includes a processor-readable medium (such as a storage device) having instructions for carrying out a process. Further, a processor-readable medium can store, in addition to or in lieu of instructions, data values produced by an implementation.

As will be evident to one of skill in the art, implementations can use all or part of the approaches described herein. The implementations can include, for example, instructions for performing a method, or data produced by one of the described embodiments.

A number of implementations have been described. Nevertheless, it will be understood that various modifications can be made. For example, elements of different implementations can be combined, supplemented, modified, or removed to produce other implementations. Additionally, one of ordinary skill will understand that other structures and processes can be substituted for those disclosed and the resulting implementations will perform at least substantially the same function(s), in at least substantially the same way(s), to achieve at least substantially the same result(s) as the implementations disclosed. Accordingly, these and other implementations are contemplated by this disclosure and are within the scope of these principles.

1. A method for interfacing with a reference image, comprising the steps of:
capturing an image comprising a reference image;
identifying a portion of the captured image that corresponds to the reference image;
normalizing said identified portion of the captured image with respect to the reference image;
calculating a difference between the normalized portion of the captured image and the reference image for at least one image region;
determining if at least one difference exceeds a threshold for at least some period of time, and
taking an action in response to said determining step.

2. The method of claim 1, wherein the reference image comprises video objects for initiating an action.

3. The method of claim 2, wherein the video objects are pushbuttons.

4. A method for interfacing with a reference image, comprising the steps of:
capturing an image comprising pushbuttons;
identifying regions comprising pushbuttons in the captured image;
comparing a measure of the regions comprising pushbuttons with respect to each other;
determining if any measure exceeds a threshold for at least some period of time, and
taking an action in response to said determining step.

5. An apparatus for interfacing with a reference image, comprising:
a camera that captures an image;
an image reference matcher for identifying a portion of the captured image that corresponds to a reference image;
a normalizer for normalizing said identified portion of the captured image with respect to the reference image;
a difference calculator for generating a difference between the normalized portion of the captured image and the reference image for at least one image region;
a comparator for determining if at least one difference exceeds a threshold for at least some period of time; and
circuitry for taking an action in response to said comparator determination.

6. The apparatus of claim 5, wherein the reference image comprises video objects for initiating an action.

7. The apparatus of claim 5, wherein the video objects are pushbuttons.
